(19) United States
(12) Patent Application Publication
(10) Pub. No.: US 2011/0200750 A1
(43) Pub. Date: Aug. 18, 2011

(54) METHODS FOR MANUFACTURING PANELS AND PANEL OBTAINED HEREWITH

(75) Inventors: Laurent Meersseman, Kortrijk (BE); Peter Provoost, Jamestown, NC (US); Bart Verhaeghe, Dranouter (BE)

(73) Assignee: FLOORING INDUSTRIES LIMITED, SARL, Bertrange (LU)

(21) Appl. No.: 13/125,666

(22) PCT Filed: Oct. 27, 2009
(86) PCT No.: PCT/IB2009/054761

§ 371 Date: Apr. 22, 2011

(30) Foreign Application Priority Data
Nov. 13, 2008 (BE) BE 2008-0616

(51) Int. Cl. B05D 5/00; B05D 3/00

(52) U.S. Cl. 427/256

(57) ABSTRACT

Method for manufacturing panels of the type which is composed at least of a substrate and a top layer with a printed decor, wherein the top layer comprises at least two material layers, and wherein for manufacturing, one starts from larger boards, wherein the method consists at least of providing said two material layers and performing a print directly on the substrate material, wherein at least a first of said two material layers is provided on the surface of the larger board before it is subdivided, whereas at least a second of said two material layers is provided on the surface of one or more of the smaller panels obtained by subdividing.

### BACKGROUND OF THE INVENTION

1. Field of the Invention

This invention relates to methods for manufacturing panels, as well as panels which can be obtained by means of such methods.

2. Related Art

More particularly, the invention relates to methods for manufacturing panels of the type which is composed at least of a substrate and a top layer with a printed decor, said top layer being provided on this substrate. This may relate, for example, to furniture panels, ceiling panels, floor panels or the like, which substantially consist of a MDF or HDF (Medium or High Density Fiberboard) basic panel or substrate and a top layer provided thereon. In particular, it relates to a method wherein one or more material layers are provided on the substrate, wherein at least one of these material layers is provided by means of a print, which is performed directly on the substrate, wherein this print then forms at least a portion of said printed decor.

Such panels are known as such, for example, from U.S. Pat. No. 1,971,067 or DE 195 32 819 A1. From the aforementioned documents, it is also known that said material layers may comprise one or more basic layers, wherein these basic layers substantially extend below said print, and/or may comprise one or more finishing layers, which substantially extend above said print. Such finishing layers may comprise, for example, transparent or translucent synthetic material layers, which form a protective layer above the printed decor and may comprise, for example, wear-resistant particles, such as aluminum oxide. It is not excluded that this protective layer comprises a material sheet, such as a paper sheet.

The state of the art in respect to panels provided with a print performed directly on the substrate further also becomes clear from the documents WO 01/48333, WO 02/00449, WO 2004/042168 and DE 10 2004 009 160 A1.

### SUMMARY

According to its various independent aspects, the present invention in particular aims at offering alternative methods of the above-mentioned type, which, according to various preferred embodiments thereof, can be performed more smoothly and/or more economically than the methods of the state of the art.

To this aim, the invention, according to its first independent aspect, relates to a method for manufacturing panels of the type which is composed at least of a substrate and a top layer with a printed decor, said top layer being provided on this substrate, wherein the top layer comprises at least two material layers and wherein for manufacturing, one starts from larger boards, from which boards, by subdividing them, a plurality of said substrates or panels can be formed, wherein the method consists at least of providing said two material layers and performing a print directly on the substrate material, wherein this print forms at least a portion of said printed decor, with the characteristic that at least a first of said two material layers is provided on the surface of the larger board before it is subdivided, whereas at least a second of said two material layers is provided on the surface of one or more of the smaller panels obtained by subdividing. It is clear that said print directly performed on the substrate material also may form part of at least one of said two material layers. Further, it is clear that said material layers preferably cover substantially the entire respective surface, either of the larger board or of the smaller panels. However, it is not excluded that according to a particular embodiment, at least one of said material layers, preferably said second material layer, covers only a portion of the respective surface, for example, an edge portion of said panels. It is possible that this relates to an edge portion which is obtained during or after said subdividing. Thus, the method may be applied for manufacturing panels having profiled edge regions at their edges, wherein the respective material layer then extends at least or substantially on these profiled edge regions. In the case that one or more of said profiled edge regions comprise a chamfer, it is possible that said second material layer extends at least or substantially on said chamfer. As aforementioned, the surface of said chamfer preferably is obtained at least partially during or after said subdividing. However, it is not excluded that this surface is realized prior to subdividing said larger board, for example, by means of a deforming or machining treatment performed on the larger board.

As one or more material layers are provided on said larger board and one or more material layers are performed on the smaller panels obtained by subdividing, a splitting of the treatments can be obtained, which is economical and still offers a good result. For example, it is possible to perform one or more treatments prior to performing the print on the larger board. Such treatments may comprise, for example, performing a grinding treatment. The material layers which are applied on the surface of the larger board preferably comprise a basic layer of uniform or at least quasi-uniform color. Prior to applying such basic layer, unevennesses at the surface of the larger board possibly may be filled by means of a material layer comprising a filling agent. At the surface of the larger board, also a sealing material layer can be used, and/or a material layer serving as a primer for retaining colorants, such as inks or paints, which colorants have to be applied later on. So, for example, one or more ink-receptive layers can be applied.

Said material layers, such as filling material layers, basic layers, sealing layers or primer layers, can be applied more simply, precisely and/or smoothly on a large surface than on the surface of smaller panels.

In the case of the above particular embodiment, it is possible that the step of subdividing is performed after such basic layers and/or primer layers have been provided on the surface of the larger boards, that during subdividing, an edge portion is realized, for example, in the form of a chamfer, and that on the respective edge portion similar or other basic and/or primer layers are provided, as a result of which as such already a first material layer and a second material layer are created, which are provided according to a method with the characteristics of the invention, and that the print, whether or not in several separate steps, is provided both on the actual surface of the smaller panel and on the edge portion concerned. Hereafter, then one or more finishing layers can be provided at least on the actual surface and/or on the respective edge portion. Preferably, the finishing layers of the actual surface and of the edge portion are provided at the same time. However, it is not excluded that the finishing layers might be provided in separate steps.

Preferably, said first material layer is applied in liquid form. As aforementioned, said first material layer preferably relates to a basic layer or primer layer. For application in liquid form, one or more rollers can be applied, and/or jetting or spraying installations can be used.

It is not excluded that the aforementioned material layers which are provided on the surface of the larger board comprise a material sheet, such as a paper layer or a foil. In such case, said first material layer can be applied by means of a press treatment. Such material sheet can be provided with synthetic material, for example, with a synthetic material which can realize the connection with the board surface. For example, an amino resin, such as melamine formaldehyde resin, can be used. However, also glue, such as phenol glue, can be used. When working with one or more material layers comprising material sheets, best one or more, or still better, all such material sheets are provided on the surface of the larger board. Application techniques suitable for applying material layers are more advantageous when applied to larger surfaces.

According to a preferred embodiment, the surface of the larger board, before the latter is subdivided, is subjected to a press treatment. As aforementioned, this press treatment can be applied for providing a material layer on the surface, however, can also be applied for providing, for example, a relief on the surface. A press treatment is economically more advantageous when it can be applied on larger surfaces. Moreover, it is possible, however, not essential, in the case of a plurality of material layers comprising material sheets, to apply those simultaneously by means of the same press treatment.

It is preferred that prior to subdividing the larger board, a relief or a structure is realized at the surface of this larger board. Such relief may consist, for example, of a wood structure, a stone structure, a structure of joints, such as cement joints or chamfers. For obtaining such relief, as aforementioned, a press treatment can be applied. For this purpose, a structured press element, such as a press plate or a press cylinder, can be provided, wherein this press element has a structure of projections and/or recesses at its surface and wherein this structure or this relief is pressed into the surface of the larger board. Possibly, the larger board herein already may have been provided with one or more material layers and may such relief possibly, however, not essentially, be restricted to a deformation of at least one of these material layers. When performing said press treatment, it is possible to work with a heated press element and/or to moisten the substrate, for example, by means of water or ammonia. In this manner, for example, a material layer comprising resin and/or a substrate on the basis of wood particles or wood fibers, respectively, can be deformed more simply.

Preferably, said step of subdividing is performed prior to performing said print. Said larger board, when being subdivided, preferably is free from motifs which will be present in the final printed decor. In this case, during subdividing the print of other motifs do not have to be taken into account, or in a limited manner only. However, when the print indeed has been applied prior to subdividing, the subdividing process best will take into account the printed decor segments which are depicted on the board, such that the final smaller panels will show the desired decor. Such subdivision in function of the printed decor considerably increases the complexity of the manufacture of such panels. It is also possible that said print partially is performed prior to subdividing the board and partially during and/or after subdividing the board. For example, in case of the above-mentioned particular embodiment, it is possible that the actual surface is printed prior to subdividing the board, whereas the edge portion mentioned there only is printed during or after subdividing the larger board.

It is noted that applying two or more print portions in separate steps, wherein at least one of these steps is performed prior to subdividing the board and at least one of these steps is performed on the smaller panels, as such forms an example of said first aspect of the invention. It is clear that said first material layer and said second material layer then are considered as the print portion provided on the larger board and the print portion provided on the smaller panels, respectively. Preferably, however, at least one of said two material layers, and still better both material layers, which are provided according to the invention, are free from patterns and/or ink.

Preferably, said larger board, during said step of subdividing, is subdivided into panels having a size which corresponds to the final panels.

In a preferred embodiment, the method further also comprises the step of forming profiled edge regions at the panels, wherein this step preferably is performed before said second material layer is provided.

Said second material layer preferably at least relates to said print. As already mentioned above, it is preferred to perform the print directly on the surface of the smaller panels. Providing the print as late as possible in the production chain reduces the required storage space and enables a fast reaction to the demands of the market. However, it is not excluded that at least a portion of the print, or possibly the entire print, is performed on the larger boards, in other words, prior to subdividing these boards.

Said second material layer preferably at least relates to a transparent material layer which is applied above said print. Such material layer possibly may comprise a material sheet, such as a paper sheet, however, may also substantially consist of synthetic material. For example, a lacquer, such as a UV-hardening or electron beam-hardening lacquer, can be applied. Such transparent material layer preferably also comprises hard particles, for example, aluminum oxide particles.

According to a second independent aspect, the present invention relates to a method for manufacturing panels of the type which is composed at least of a substrate and a top layer with a printed decor, said top layer being provided on this substrate, wherein the method consists at least of providing, on a flat side of the substrate material, one or more material layers, which substantially extend over the entire respective flat side of the substrate, and wherein at least one of these material layers is applied by means of a print performed directly on the substrate material, wherein this print forms at least a portion of said printed decor, with the characteristic that at least one of said material layers extends up onto the edge of said panels, wherein the portion of the respective material layer situated on said respective flat side and the portion of this material layer situated on said edge are realized in the same treatment step. It is clear that the respective treatment step best is performed while the panels already mainly show their final dimensions, and that the respective material layer preferably extends uninterruptedly from the top surface of the panel up onto the edge. Thus, the respective treatment step is performed, for example, after the smaller panels have been obtained from a larger board by means of subdividing. The remaining material layers may or may not be provided on the surface of the larger board prior to performing said possible subdividing, and the method of the second aspect thus may or may not also show the characteristics of said first aspect or the preferred embodiments thereof.

The method of the second aspect allows obtaining new effects, such as, for example, watertightness also on the edges of the panel, in a smooth manner. Preferably, this relates at least to a material layer which is free from motifs. However, it is not excluded that said material layer, which extends up onto the edge of said panels, is at least formed by said print.

It is noted that it is known as such from documents EP 1 762 671 and EP 1 479 524 to provide the edges of a panel with a motif by means of a print. Herein, however, each time a separate print is performed on the edges. Thus, herein prints are concerned which have been provided in separate treatment steps.

Preferably, said panels show profiled edge regions at their edges, which edge regions comprise at least coupling means for coupling together two of such panels, wherein the respective material layer extends up onto said coupling means, or still better covers these latter substantially or entirely. When the respective material layer, which continues up onto the edge, comprises at least a basic layer, which is performed in a basic color corresponding to the printed decor, the special effect can be obtained that the final panel has the appearance of a solid panel, such as of a panel for solid parquet.

Preferably, said panels have profiled edge regions at their edges, which edge regions comprise at least a chamfer, wherein the respective material layer extends up onto said chamfer or, still better, covers the latter substantially or entirely. When the respective material layer, which continues up onto the edge, comprises at least a basic layer which is performed in a basic color corresponding to the printed decor, a matching decorative covering is provided on the surface of said chamfer in a particularly smooth and economic manner. This is in particular the case when the print is absent on this chamfer, however, the respective material layers, which continue op onto the edge, possibly also comprise a transparent or translucent protective layer.

Preferably, said material layer extends on the edge up to the underside of the respective panel and in this manner covers the entire respective edge. Still better, the respective panel becomes entirely encapsulated by means of said panels. Preferably, said substrate is encapsulated at all sides by means of one or more material layers. At the underside of the substrate, for example, a counteracting layer or balancing layer can be provided, whereas the respective material layer is situated at the upper side and at all edges of the panel.

According to a preferred embodiment, and as already mentioned, said material layers comprise at least a basic layer extending substantially below said print, wherein this basic layer relates to said material layer extending up onto the edge of said panels. In this manner, it is possible to provide the edges of the panel with a basic color, too, such that the substrate situated there obtains a color matched to the printed decor. Whether or not in combination with said basic layer, it is possible that the respective material layer comprises a sealing layer and/or primer layer and/or comprises a provided on top thereof transparent or translucent protective layer. According to an important embodiment, however, the printed decor of this edge is omitted.

According to another preferred embodiment, said material layers comprise at least one finishing layer extending substantially above said print, wherein this finishing layer relates to said material layer extending up onto the edge of said panels. Herein, this relates, for example, to a lacquer layer on the basis of an UV-lacquer or electron beam-hardening lacquer, which may or may not comprise hard particles, such as aluminum oxide. Of course, it is not excluded to apply water-based UV-lacquer. According to an important embodiment thereof, the respective edge is free from the material layer forming the printed decor.

Preferably, the respective material layer is applied as a liquid substance. Liquid substances are easier to apply over an edge than material layers comprising, for example, a paper layer. Preferably, the respective substance is provided by means of rollers, a jetting or spraying installation and/or a so-called vacumat. Preferably, prior to applying the respective material layers extending up onto the edge, at least a treatment under negative pressure is applied, as it is the case in the aforementioned vacumat. For an example of a vacumat spraying head known as such, reference is made to DE 92 02 976 U1. Such spraying heads are applied now already, for example, for applying certain substances on the edges of panels in a continuous manner, such as described, for example, in the document WO 2008/078181.

Preferably, the respective edge of the final panel is free from motifs.

Preferably, the respective material layer situated on the edge has a water-repellent and/or water-tight effect. To this aim, for example, one or more layers consisting of UV-lacquer can be applied.

According to a third independent aspect, the present invention relates to a method for manufacturing panels of the type which is at least composed of a substrate and a top layer with a printed decor, said top layer being provided on this substrate, wherein the method consists at least of providing, on a flat side of the substrate material, one or more material layers, which substantially extend over the entire respective flat side of the substrate, and wherein at least a first of these material layers is applied by means of a print performed directly on the substrate material, wherein this print forms at least a portion of said printed decor and wherein also a structure is realized on the respective flat side of the substrate material, with the characteristic that at least a second of said material layers is provided on the respective flat side by means of a treatment under negative pressure. It is clear that said structure may be restricted to the deformation of one or more material layers, which are provided on the substrate. Further, it is clear that the method of the third aspect also additionally may show the characteristics of the first and/or of the second aspect of the invention and/or of the preferred embodiments of these aspects.

The inventors have found that applying a material layer by means of a treatment under negative pressure is ideally suited for manufacturing panels having a structure, as such material layer can be realized very thin and, during the application thereof, retains possible structures already present at the surface and/or can be provided with a structure in a simple manner.

Preferably, said second material layer is provided after said structure already has been realized. Surprisingly, the inventors have found that it is possible that this second material layer, as it is provided by means of a treatment under negative pressure, is provided up into the impressions of such structure, even when, for example, impressions for imitating wood pores are concerned. Such impressions are long, narrow and relatively deep.

The invention also has advantages when the structure is realized only after the respective material layer has been provided by means of negative pressure.

Preferably, said second material layer relates to a transparent layer, which is applied above said print. Such transparent layer may comprise a lacquer, such as, for example, an UV(ultraviolet)-hardening or electron beam-hardening lacquer, which preferably also comprises hard particles, such as aluminum oxide. According to another possibility, said second material layer preferably comprises a basic layer, which in the final panel will be situated below said print.

Preferably, said structure is realized by means of a press treatment with a structured press element. For this purpose, the press elements and techniques also mentioned herein above in connection with the first aspect can be applied.

According to a fourth independent aspect, the invention also relates to a method for manufacturing panels of the type which is composed at least of a substrate and a top layer with a printed decor, said top layer being provided on this substrate, wherein the method consists at least of providing, on a flat side of the substrate material, one or more material layers, which substantially extend over the entire respective flat side of the substrate, and wherein at least one of these material layers is applied by means of a print performed directly on the substrate material, wherein this print forms at least a portion of said printed decor, with the characteristic that at least one of said material layers extends on the edge of said panels, wherein the portion of the respective material layer situated on said respective flat side and the portion of this material layer situated on said edge are realized in separate treatment steps.

Preferably, the method of the fourth aspect is applied for manufacturing panels having a profiled edge region at least at one edge. Preferably, the portion of the material layer situated on said edge at least extends on this profiled edge region. Such profiled edge region may comprise, for example, a chamfer. The respective material layer preferably extends at least on said chamfer or still better substantially extends on said chamfer.

Preferably, the material layer of the fourth aspect, which has been provided in at least two separate steps, at least relates to a material layer which is situated below said print. For examples of material layers situated below a print, reference is made to the above-described aspects of the present invention. Preferably, all material layers, or at least the majority of the material layers, which are situated below the print, are provided each time in at least two such separate steps, or, in other words, they each time show at least two portions which are provided separately, namely, a first portion which is provided on the actual surface of the board or the panels and a second portion which is provided on the surface of an edge portion of the panels.

It is clear that said fourth aspect does not exclude that the two portions of the respective material layer both are provided on a larger board prior to subdividing the latter. It is also possible that only one or none of these portions are provided on the larger board. In such case, one or both portions of the respective material layer are provided on the smaller panels.

The methods of the invention, according to all of its aspects, preferably are applied for manufacturing panels having a structure at their surface, which structure is performed in accordance with said print. Preferably, this relates to a print with a wood pattern.

According to all of its aspects, the invention preferably is applied for manufacturing floor panels and/or panels, of which said substrate material substantially consists of MDF or HDF or another wood-based material.

For performing said print, according to all aspects preferably the technique of offset printing or the technique of inkjet printing is applied. The technique of inkjet printing is well suited for performing prints on the surface of smaller panels already having the approximate dimensions of the final panels, whereas the technique of offset printing rather is suited for printing on larger boards, or for printing a plurality of smaller panels at the same time. Of course, this does not exclude that the technique of inkjet printing might be applied for printing larger boards, or that the technique of offset printing might be applied for printing the smaller panels.

It is clear that the invention also relates to a panel which is obtained by means of a method with the characteristics of the first and/or the second and/or the third aspect.

### BRIEF DESCRIPTION OF THE DRAWINGS

With the intention of better showing the characteristics of the invention, hereafter, as an example without any !imitative character, several preferred embodiments are described, with reference to the accompanying drawings, wherein:

FIG. 1 schematically represents some steps in a method according to the present invention;

FIG. 2 represents a view on the area indicated by F2 in FIG. 1, for a variant;

FIG. 3, at a larger scale, represents a cross-section according to the line III-III indicated in FIG. 2; FIG. 4, in a similar view as that of FIG. 3, shows a variant;

FIG. 5, in a similar view as that of FIG. 4, represents a finished panel;

FIG. 6, at a larger scale, represents a cross-section according to the line VI-VI indicated in FIG. 1; and

FIGS. 7 to 9, in views on a similar region as the one indicated by F7 in FIG. 6, represent some steps in a method showing, amongst others, the characteristics of the fourth aspect of the invention.

### DESCRIPTION OF EXAMPLE, NON-LIMITING EMBODIMENTS OF THE INVENTION

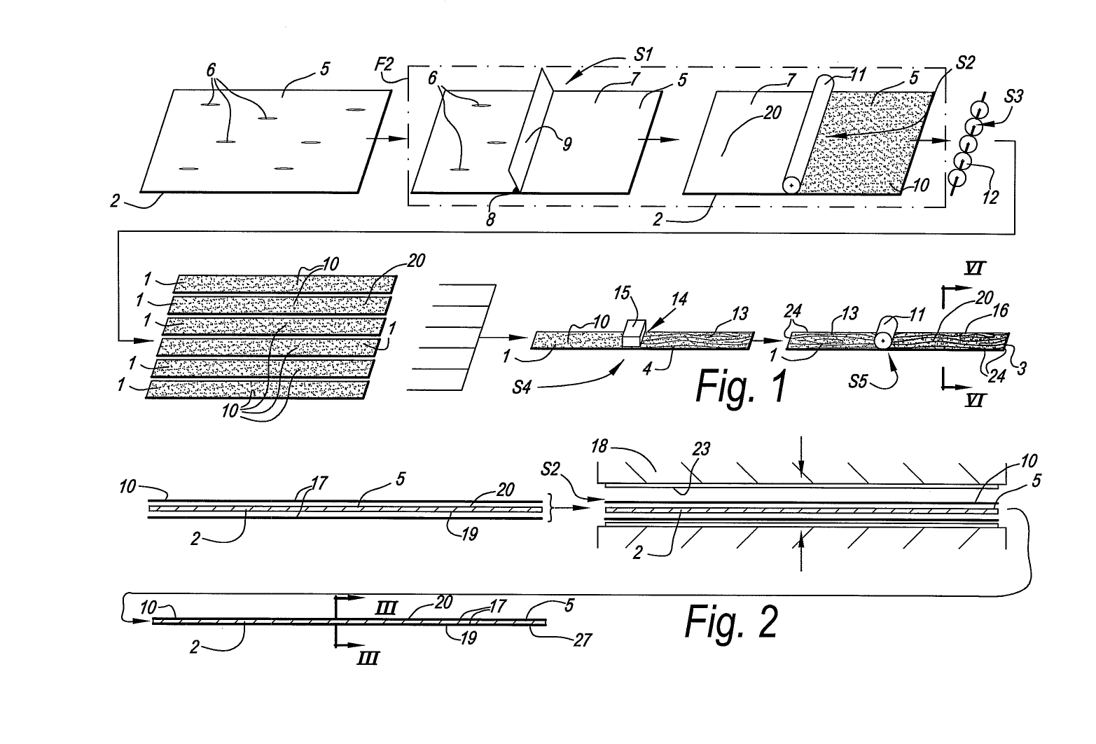

FIG. 1 represents some steps S1-S5 of a method for manufacturing panels 1, with the characteristics of, amongst others, the first aspect of the present invention. Herein, this relates to a method for manufacturing panels 1 of the type which is composed at least of a substrate 2 and a top layer 3 with a printed decor 4, said top layer being provided on this substrate 2. In the example of FIG. 1, specifically a method is illustrated for manufacturing floor panels 1 with a wood-based substrate 2, such as with a substrate on the basis of MDF or HDF. To the person skilled in the art, it is clear how a similar method for manufacturing other panels 1 can be obtained.

For manufacturing, one starts from larger boards 5, from which in a subdividing step S3 a plurality of said substrates 2 or panels 1 can be formed. In the example of the method of FIG. 1, possible unevennesses 6 at the surface of the larger board 5 are smoothed away in a first step S1 by means of a material layer 7 with filling agent 8. In the example, the filling agent 8 is provided over the surface of the board 5 by means of a doctor blade or other spatula 9, with the intention of obtaining an even surface. Possibly, this first material layer 7 can be grinded in order to achieve the desired surface condition. A grinding operation may also be performed before applying the filling agent 8. Such grinding operation is not represented here.

In the example, in a second step S2 at least a second material layer 10 is provided on the surface of the larger board 5. Herein, this relates to a basic layer of a substantially uniform color, which is applied by means of at least a roller 11.

It is clear that in the example of FIG. 1 both said first material layer 7 and said second material layer 10 are applied in liquid form.

In a third treatment step S3, the larger board 5 is subdivided into a plurality of smaller panels 1 having approximately the dimensions of the final panels 1. In the example, this is performed by means of a multi-bladed saw 12. From the introduction, it is clear that the obtained panels 1 possibly may be provided with profiled edge regions comprising, for example, coupling means with which two of such panels 1 can be coupled to each other. The treatment step in which the possible profiled edge regions are realized, is not represented here. Such treatment step can take place at any time after performing said subdividing step S3. In the example of FIG. 1, the large board 5, when being subdivided, is free from motifs, which may render the performance of the subdividing step S3 extremely smooth.

In a fourth treatment step S4, a material layer 13 is applied in the form of a print 14, which is performed directly on the substrate material 2. This print 14 forms at least a portion of the printed decor 4 of the final panels 1. The represented print 14 relates to a print 14 with a wood pattern. As shown, it is possible that said basic layer 10 co-determines the appearance of the panel 1. In the example, the print 14 is performed by means of a digital printing device 15, such as by means of an inkjet printer. The panels 1 can be printed separately one after the other, as well as a plurality thereof simultaneously next to each other, whether or not by applying a plurality of printing devices 15. It is clear that here preferably a multi-color printing device is concerned.

In a fifth treatment step S5 finally a translucent or transparent material layer 16 is applied, which in the final floor panel 1 will be situated above the material layer 13 which is applied by means of a print 14. As aforementioned, such layer 16 may consist, for example, substantially of lacquer and hard particles. In the example, it is provided by means of at least a roller 11. It is clear that other application devices, too, may serve for this purpose, such as jetting or spraying devices or devices using an applying technique under negative pressure.

It is clear that for the method according to the first aspect of the invention, it is not necessary that all steps S1-S5 represented in FIG. 1 are applied. The essence of the invention consists in that at least one material layer 7-10 is provided prior to subdividing the larger board 15 during said subdividing step S3, and at least one material layer 13-16 is provided after the board 5 has been subdivided into smaller panels 1, whether or not having the dimensions of the final panels 1. Also, it is clear that still other layers than those illustrated by means of FIG. 1 can be applied and that still other techniques can be used for applying the different material layers.

FIG. 2 represents an alternative technique for providing one or more material layers 7-10 on the larger boards 5. Hereby, this relates to a technique for applying a material layer 10, which comprises a material sheet 17, such as a foil or a paper layer. For applying the material layer 10 concerned, a press treatment by means of a press device 18, in this case a press device which opens and closes (in German: Kurztaktpresse), is applied. The substrate 2 and the material layer 10 to be applied thereon are brought into the press and there are attached to each other by means of increased pressure and temperature. In the example, at the same time also a material sheet 17 is attached to the underside 19 of the substrate 2. In this way, the risk of a warping of the boards 5 after being pressed can be minimized. The actual connection of the material sheets 17 with the substrate 2 is achieved directly or indirectly, in that resin or other synthetic material, which is provided on the material sheets 17 concerned and/or on the respective surfaces of the substrate 2, due to said temperature starts flowing and solidifies.

For the material sheet 17, which is provided directly or indirectly at the upper side 20 of the substrate 2, preferably a material sheet 17 of uniform color or of quasi-uniform color, such as a white sheet of paper, can be applied. It is clear that this material sheet 17, in order to achieve a smooth subdividing step S3, preferably is free from motifs.

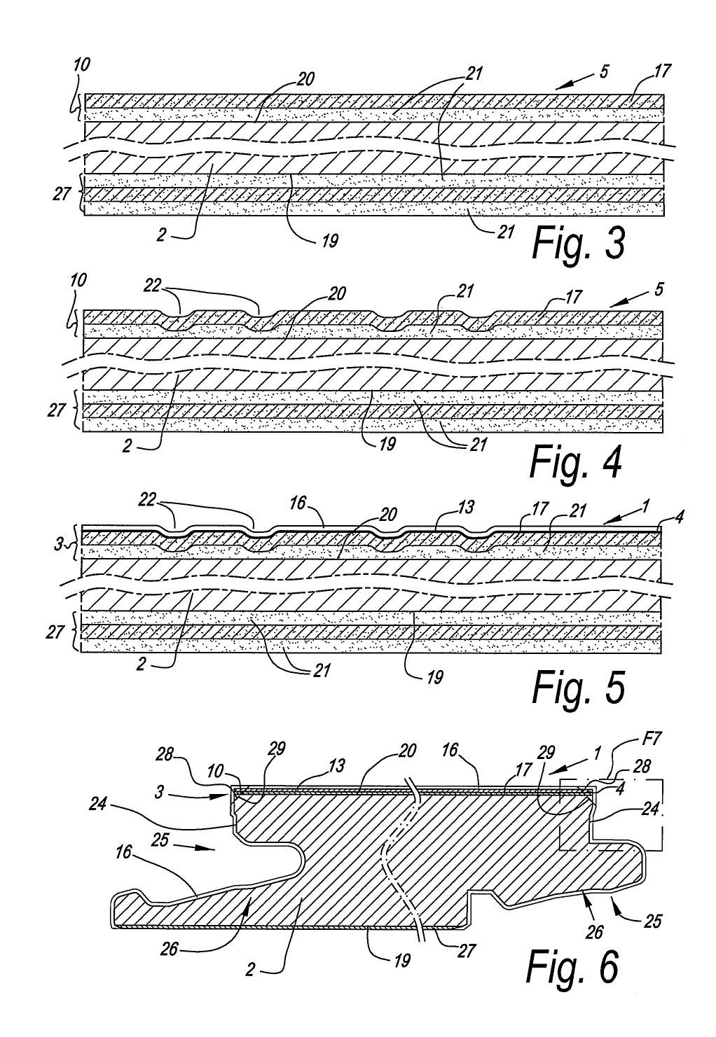

FIG. 3 schematically shows a section through the board 5 obtained by pressing. In this section, the substrate 2, both material sheets 17 and the respective synthetic material or resin 21 are clearly visible. It is noted that at the exterior surface of the upper side 20 preferably no resin 21 is present, or at least less resin 21 is present than at the exterior surface of the underside 19 of the board 5.

FIG. 4 represents the case wherein at the surface of the larger board 5, prior to its subdividing, a relief 22 is realized. This relief 22 can be realized, for example, during said press treatment, when a structured press element 23 is used in the press device 18. The relief may also be obtained in a separate treatment step.

In the represented example, the impressions or the relief 22 remain restricted to the material layers 7-10-13-16 provided on the substrate 2. However, this does not necessarily have to be so, as also the substrate 2 may be deformed to a greater or lesser extent in order to obtain a relief 22. Also, a combination is possible, where larger recesses are realized in the relief 22 by deforming the substrate 2, and smaller recesses by deforming solely one or more of the situated thereabove material layers 7-10-13-16. The deformations of the substrate 2, the material layers 7-10-13-16 situated thereabove, respectively, do not necessarily have to be realized during said press treatment. They may also be obtained, for example, in a separate press treatment, or may be obtained by performing machining treatments on the substrate 2 and/or the material layers 7-10-13-16 situated thereabove.

FIG. 5 represents that the material layer 13 formed by the directly performed print 14 and the transparent or translucent material layer 16, which is provided above the print 14, hardly or not at all affect the relief 22 provided in earlier steps. This surely is the case when prior to applying the transparent or translucent material layer 16 at least a treatment under negative pressure is applied. This may take place, for example, by applying a vacumat.

FIG. 6 shows that it is possible that at least one of said material layers 16 extends up onto the edge 24 of said panels 1, wherein the portion of the respective material layer 16 which is situated on said upper side 20 of the substrate 2, and the portion of this material layer 16 which is situated on said edge 24, are realized in the same treatment step. In the represented case, a finishing layer 16, which extends above the printed decor 4, more particularly said transparent or translucent material layer, covers the entire profiled edge regions 25 of the floor panel 1. Herein, this relates to profiled edge regions 25, which at least comprise coupling means 26 for coupling together two of such panels 1.

It is clear that instead of working with a finishing layer 16 extending up onto the edge 24, one may also work with a basic layer 10 extending, for example, up onto the coupling means 26 or covering these completely. Preferably, however, the respective edge 24 or the respective profiled edge region 25 remains free from motifs.

In the example of FIG. 6, a complete encapsulation of the panel 1 is achieved by means of at least the aforementioned finishing layer 16 and the backing layer 27. Depending on the substance of the finishing layer 16, then a complete water-repelling or waterproofing protection of the substrate 2 can be obtained. This is of particular importance when working with porous substances 2, such as with substances on the basis of MDF or HDF.

Such complete encapsulation can be obtained in a smooth manner when, prior to applying the respective material layer 10-16, the finishing layer 16 and/or the basic layer 10, which covers the edge 24, a technique is used for application under negative pressure.

According to a variant, which is represented by means of the dashed lines 28, the floor panels 1, which are obtained according to the methods of the invention, may be provided with profiled edge regions 25, which, apart from coupling means 26, comprise chamfers 29. In the represented example, this relates to chamfers 29 in the form of bevels. Chamfers 29 may be situated at one edge 24 or, such as here, at two opposite edges, or possibly at all edges 24. Preferably, a decorative covering is provided on the surface of the chamfers 29.

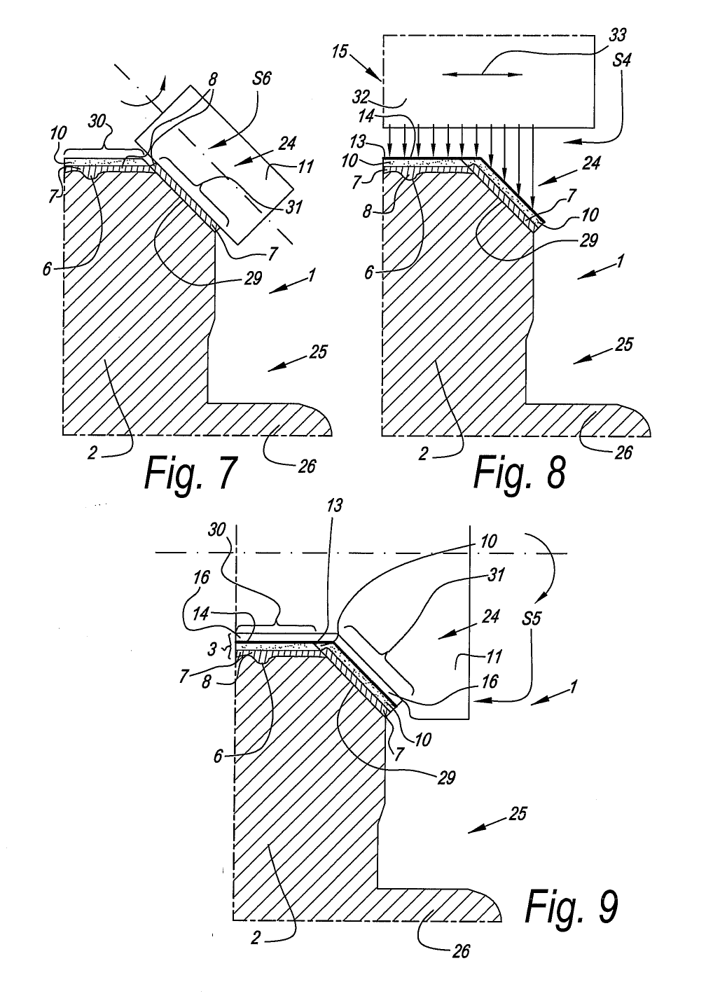

FIG. 7 represents that for manufacturing a floor panel 1, the profiled edge regions 25 of which show one or more chamfers 29, for example, a method with the characteristics of the fourth aspect can be applied. Herein, both the actual surface or the flat side of the panel 1, or possibly the larger board 5 are provided with one or more material layers 7-10-13-16, wherein at least one of these material layers 7-10-13-16 extends up to the edge 24 of the respective panels 1. According to the fourth aspect, the portion 30 of the respective material layer 7-10 which is situated on said flat side and the portion 31 of this material layer 7-10 which is situated on said edge 24 are realized in separate treatment steps S1-S2-S6. In the example of FIG. 7, at least the material layer 7 with the filling agent 8 shows such portions 30-31. From FIG. 8, it is clear that at least the basic layer 10 also shows such portions 30-31.

For realizing the portion 30 of the material layers 7-10 on the flat side of the respective panels 1, for example, step S1 and step S2 of FIG. 1 can be applied. However, it is not excluded that for realizing these portions 30-31, use is made of one or more techniques which are active on the surface of the smaller panels 1 instead of the larger boards 5.

FIG. 7 represents that after the subdividing operation S3, the surface of the chamfer 29 is provided with filling agent 8 in a separate treatment step S6. Here, this is performed by means of a rotating roller or cylinder 11. For realizing the portion 31 of the basic layer 10 on the surface of the chamfer 29, which is represented in FIG. 8, one may or may not proceed in a similar manner.

FIG. 8 represents that the flat side of the panels 1 as well as the surface of one or more chamfers can be provided with a printed decor by means of the same printing operation S4. As represented, in this case a printing device 15 with moving inkjet print heads 32 is applied. As indicated by the arrow 33, the print heads 32 herein move transversely to the longitudinal direction of said chamfers 29. However, it is not excluded that the print heads move parallel to this longitudinal direction or stand still, whereas the panel 1 moves beneath these print heads. Printing may or may not be performed in several passes.

It is clear that according to a variant, the surface of the chamfer 29 can be provided with a decorative covering in a separate printing step.

FIG. 9 also represents that the obtained print 14 in a step S5 also can be provided with one or more transparent or translucent material layers 16. In the example, this material layer 16 is applied by means of a soft roller 11. This roller 11 is able to provide in one treatment the flat side of the panel 1 as well as the surface of the chamfer 29 with such material layer 16. By means of such method, also an embodiment according to the second aspect of the invention, mentioned in the introduction, can be obtained. According to the invention in general, however, it is not necessary that the material layer 16 is provided on both surfaces in a single treatment. Possibly, the respective portions 30 and 31 may be provided on the respective surfaces in separate treatment steps.

It is clear that the method as explained in connection with the FIGS. 7 to 9 also forms an example of the particular embodiment of the first aspect of the invention, mentioned in the introduction, wherein the first material layer mentioned there, for example, is a portion 30 of the material layer 7-10 which is situated on the flat side of the larger boards 5, and the second material layer mentioned there, for example, is a portion 31 of the material layer 7-10 which is provided on the surface of the chamfer 29.

The present invention is in no way restricted to the above-described embodiments;

on the contrary may such methods and panels be realized according to various variants, without leaving the scope of the present invention.

1. A method for manufacturing panels of the type which is composed at least of a substrate and a top layer with a printed decor, the top layer being provided on the substrate, wherein the top layer includes at least two material layers, the method comprising;
subdividing a larger board into a plurality of the substrates;
providing the two material layers; and
performing a print directly on one or more of the substrates or the larger board;
wherein the print forms at least a portion of the printed decor;
wherein at least a first of the two material layers is provided on the surface of the larger board before it is subdivided; and
wherein at least a second of the two material layers is provided on the surface of one or more of the substrates obtained by subdividing.

2. The method of claim 1, wherein the first material layer is applied in liquid form.

3. The method of claim 1, wherein the first material layer relates to a basic layer or primer layer.

4. The method of claim 1, wherein the first material layer comprises a foil.

5. The method of claim 4, wherein the first material layer is provided by means of a press treatment.

6. The method of claim 1, further comprising:
subjecting the larger board to a press treatment prior to subdividing the larger board.

7. The method of claim 1, further comprising:
providing a relief in the surface of the larger board prior to subdividing the larger board.

8. The method of claim 1, wherein the step of subdividing the larger board is performed prior to performing the print.

9. The method of claim 1, wherein the larger board during the step of subdividing is subdivided into substrates having a size which corresponds to the final panels.

10. The method of claim 1, further comprising:
forming profiled edge regions at the substrates prior to providing the second material layer.

11. The method of claim 1, wherein the second material layer relates to the material layer which is provided by means of the print.

12. The method of claim 1, wherein the second material layer relates to a transparent material layer, which is applied above print.

13. The method of claim 1, wherein the larger board, when being subdivided, is free from motifs which will be present in the final printed decor.

14. A method for manufacturing panels of the type which is composed at least of a substrate and a top layer with a printed decor, the top layer being provided on the substrate, the method comprising:
providing, on a flat side of the substrate, one or more material layers, which substantially extend over the entire flat side of the substrate;
wherein at least one of the material layers is applied by means of a print performed directly on the substrate, the print forming at least a portion of the printed decor;
wherein at least one of the material layers extends up onto the edge of the substrate,
wherein the material layer situated on both the flat side and the edge is applied in the same treatment step.

15. The method of claim 14, wherein the panels show profiled edge regions at their edges, which edge regions comprise at least coupling means for coupling together two of such panels, wherein the material layer situated on both the flat side and the edge extends up to the coupling means.

16. The method of claim 14, wherein the panels show profiled edge regions at their edges, which edge regions comprise at least a chamfer, wherein the material layer situated on both the flat side and the edge extends up onto the chamfer.

17-30. (canceled)

31. The method of claim 14, wherein it is applied for manufacturing panels having at their surface a structure which is performed in accordance with the print.

32. The method of claim 14, wherein the print shows a wood pattern.

33. The method of claim 14, wherein it is applied for manufacturing floor panels.

34. The method of claim 14, wherein the substrate substantially consists of MDF or HDF.

35. The method of claim 14, wherein for performing the print, the technique of offset printing or the technique of inkjet printing is applied.

36. A method for manufacturing panels of the type which is composed at least of a substrate and a top layer with a printed decor, the top layer being provided on the substrate, the method comprising:
providing, on a flat side of the substrate, one or more material layers, which substantially extend over the entire respective flat side of the substrate;
wherein at least one of the material layers is applied by means of a print performed directly on the substrate, the print forming at least a portion of the printed decor;
wherein at least one of the material layers extends up onto the edge of the substrate;
wherein the material layer situated on both the flat side and the edge are applied in separate treatment steps.

37. (canceled)
